(19) United States
(12) Patent Application Publication
(10) Pub. No.: US 2007/0050311 A1
(43) Pub. Date: Mar. 1, 2007

(54) Assembly should cost application

(75) Inventors: Frankie Dean Mohr, East Peoria, IL (US); Matthew Neil Garman, Peoria, IL (US); Terry William Keith, Minonk, IL (US); Fauzia Ahmed, Peoria, IL (US); Stephen Michael Tracy, Morton, IL (US); Matthew Francis Tennyson, Pekin, IL (US); Robert Wade Detloff, Morton, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/213,998

(22) Filed: Aug. 30, 2005

(51) Int. Cl. G06F 17/00; G06G 7/00

(52) U.S. Cl. 705/400

(57) ABSTRACT

A computer system for estimating the cost of an assembly has a processor and a database operably linked to the processor. The processor is configured to access an assembly cost structure stored in the database. The assembly cost structure has a bill of materials and a list of one or more core manufacturing processes. The processor is also configured to determine the cost of the assembly.

### TECHNICAL FIELD

This disclosure relates generally to a method for estimating the cost of an assembly and, more particularly, to a computer system and method of estimating assembly cost based upon material and processing costs.

### BACKGROUND

Assembly manufacture may require any number of components and processing steps to complete a finished assembly. Often assembly manufacture may be improved by utilizing standard components. Assemblies can be manufactured at reduced cost as components can be utilized across a number of different assemblies. A supplier of manufactured assemblies utilizing standard components may reduce manufacturing costs by maintaining lower inventory levels and reduced re-tooling costs when switching from the manufacture of one assembly to another. The use of standardized components may also allow multiple suppliers to manufacture an assembly, further improving manufacturing efficiencies.

Typically multiple suppliers can obtain and process the requisite components to manufacture an assembly. A buyer seeking an assembly may solicit quotations from multiple suppliers for assembly manufacture. A buyer may provide the suppliers with design specifications and a bill of materials listing the required components or component specifications. Suppliers traditionally determine a quotation for assembly manufacture based upon their own internal costing data. Upon receiving quotations from multiple suppliers, the buyer may then decide the winning bid, often based on the lowest total cost of assembly manufacture.

Advances in electronic communications and increased use of such systems have benefited computer-based bidding and procurement processes. One method that has been developed for electronic procurement of parts is described in U.S. Patent Publication No. 2004/0044591 (the '591 publication) of Gilliland et al., published on Mar. 4, 2004. The '591 publication describes an electronic procurement system for supplying parts to multiple plants that includes an electronic request for quotation (eRFQ). The eRFQ is electronically transmitted to multiple suppliers and includes part descriptions, delivery locations, and other quote information. Multiple suppliers can transmit multiple quotes through a quote management tool interface that utilizes the Internet or email-based electronic communication systems. The interface may provide the supplier with buyer approval information, design changes, cost details, interim prices, and detailed part descriptions. Multiple quotes from multiple suppliers may be compared and analyzed to determine the most cost effective solution.

Although the electronic procurement system of the '591 publication may improve the efficiency of part procurement, the system does not provide a means to compare materials or processing costs incurred during part manufacture. Further, a buyer may be unable to validate submitted quotations. If bidding suppliers have not sought the most cost effective materials or manufacturing processes, a buyer may not receive the lowest possible bid. In addition, the electronic procurement system of the '591 patent does not allow a design engineer to determine the estimated cost of an assembly prior to finalizing the design.

The computer system and method of the present disclosure are directed towards overcoming one or more of the problems as set forth above.

### SUMMARY OF THE INVENTION

One aspect of the present disclosure is directed toward a computer system for estimating the cost of an assembly. The computer system includes a processor and a database operably linked to the processor. The processor is configured to access an assembly cost structure stored in the database. The assembly cost structure includes a bill of materials and a list of one or more core manufacturing processes. The processor is also configured to determine the cost of the assembly.

Another aspect of the present disclosure is directed to a method for estimating the cost of an assembly. The method includes defining an assembly cost structure, wherein the assembly cost structure includes a bill of materials and a list of one or more core manufacturing processes. One or more suppliers is provided with access to the assembly cost structure. The method also includes receiving and storing the assembly cost structure information from the one or more suppliers. The method also includes analyzing the assembly cost structure information from the one or more suppliers. An estimated cost for the assembly is determined based on the analysis of the assembly cost structure information from the one or more suppliers.

### BRIEF DESCRIPTION OF THE DRAWINGS

FIG. 1 is a block diagram representation of a computer system architecture according to an exemplary disclosed embodiment.

FIG. 2 is a process flow chart according to an exemplary disclosed embodiment.

FIG. 3 is a pictorial illustration of one embodiment of a user implementing the disclosed system.

### DETAILED DESCRIPTION

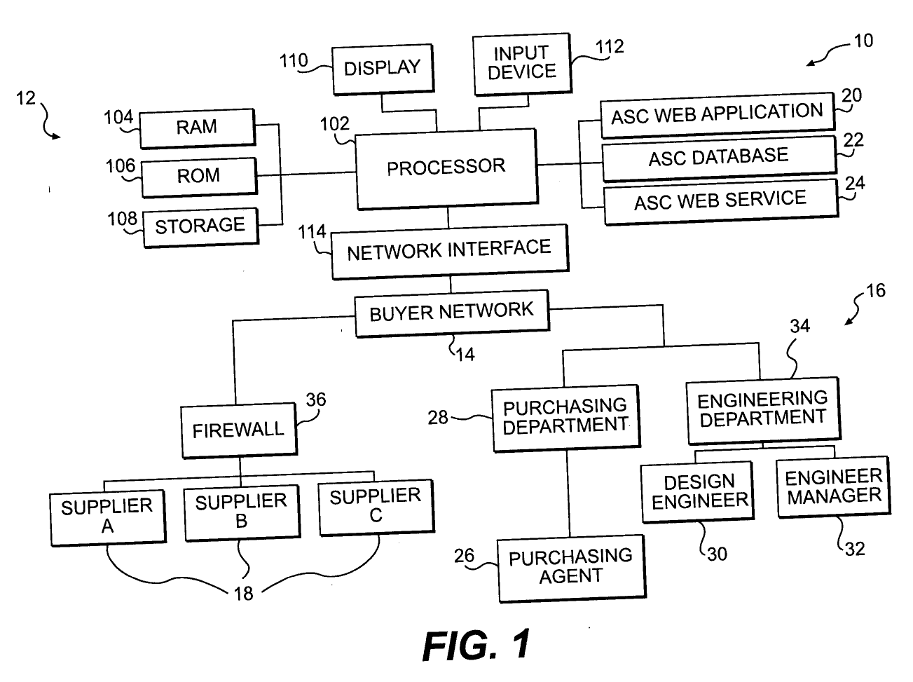

FIG. 1 shows a computer system architecture 12 of an illustrative embodiment of an “assembly should cost” (ASC) computer system 10. System architecture 12 may include a buyer network 14, such as, for example an intranet. Buyer network 14 may connect a buyer computer system 16 and/or one or more supplier computer systems 18 to ASC computer system 10. Buyer computer system 16 and/or supplier computer systems 18 may include any electronic device capable of communicating with ASC computer system 10. For example, buyer computer system 16 and/or supplier computers systems 18 may include a server, router, desktop, laptop, personal digital assistant (PDA), cellular phone, pager, etc. It is contemplated that ASC computer system 10, buyer computer system 16 and/or supplier computer systems 18 may be hosted and/or operated by third parties.

ASC computer system 10 may include a processor 102, a random access memory (RAM) 104, a read-only memory (ROM) 106, a storage 108, a display 110, an input device 112, and a network interface 114. It is contemplated that ASC computer system 10 may include additional, fewer, and/or different components than listed above. It is understood that the type and number of listed devices are exemplary and not intended to be limiting.

Processor 102 may include any appropriate type of general purpose microprocessor, digital signal processor or microcontroller. Processor 102 may execute sequences of computer application instructions to perform various processes associated with ASC computer system 10. The computer application instructions may be loaded into RAM 104 for execution by processor 102 from read-only memory 106, or from storage 108. Storage 108 may include any appropriate type of mass storage provided to store any type of information that processor 102 may need to perform the processes. For example, storage 108 may include one or more hard disk devices, optical disk devices, or other storage devices to provide any required storage.

Display 110 may provide information to users of ASC computer system 10 via a graphical user interface (GUI). Display 110 may include any appropriate type of computer display device or computer monitor (e.g., CRT or LCD based monitor devices). Input devices 112 may be provided for users to input information into ASC computer system 10. Input devices 112 may include, for example, a keyboard, a mouse, an electronic tablet, voice communication devices, or any other optical or wireless computer input devices. Network interface 114 may provide communication connections such that ASC computer system 10 may be accessed through computer networks via various communication protocols, such as transmission control protocol/internet protocol (TCP/IP), hyper text transfer protocol (HTTP), etc.

ASC computer system 10 may include one or more software systems, such as, for example, an ASC web application 20, an ASC database 22 and an ASC web service 24. The software systems may perform specific or combined functions within ASC computer system 10. In particular, ASC computer system 10 may require one or more computer systems to store and operate the software systems. ASC computer system 10 may also include software that combines one or more functions of the software systems. For example, ASC web service 24 may perform one or more functions of ASC web application 20. Additional hardware and/or software may also be required to operate ASC computer system 10, such as, for example, security applications, authentication systems, dedicated communication systems, etc. The hardware and/or software may be interconnected and accessed as required by authorized users. In addition, a portion, or all of, ASC computer system 10 may be hosted and/or operated by a third party.

Users accessing ASC computer system 10 may utilize ASC web application 20. ASC web application 20 may include an interface to allow a user access to ASC computer system 10. The interface may utilize HTML, XML, or other hypertext markup languages. It is also contemplated that ASC computer system 10 may be accessed by any appropriate interface, such as, for example, text, voice, or PDA interface systems. ASC web service 24 may include any appropriate web-hosting application and accompanying software and/or hardware.

ASC database 22 may include a relational, distributed, or any other suitable database format. A relational database may be in tabular form where data may be reorganized and accessed in various ways. A distributed database may be dispersed or replicated among different locations within a network. ASC database 22 may contain material, process and/or any assembly information. Further, ASC database 22 may include analysis tools for analyzing the information within the database.

System administrators and other information technology staff may require periodic access to ASC computer system 10. System administrators may require access to perform routine tasks, such as, for example, to update ASC code, modify access privileges, provide hardware and software maintenance, etc. It is contemplated that any number of users authorized to access buyer computer system 16 may access ASC computer system 10 via appropriate means.

Buyer computer system 16 may include any computer within the buyer organization that may require access to ASC computer system 10. Specifically, computer systems of multiple departments may access ASC computer system 10. For example, a purchasing agent 26 may access ASC computer system 10 via a computer within a purchasing department 28. Other examples may include a design engineer 30 or engineer manager 32 accessing ASC computer system 10 via a computer within an engineering department 34.

Supplier computer systems 18 may include any computer system or means to access ASC computer system 10 through appropriate security controls. In particular, one or more suppliers may operate computer systems capable of accessing ASC computer system 10. Access to ASC computer system 10 may include appropriate security controls, such as, for example a firewall 36. Firewall 36 or similar security controls may operate to limit access to ASC computer system 10 to authorized users. Access to ASC computer system 10 may be limited to approved supplier computer systems 18, third-parties and/or public computer systems with appropriate security restrictions.

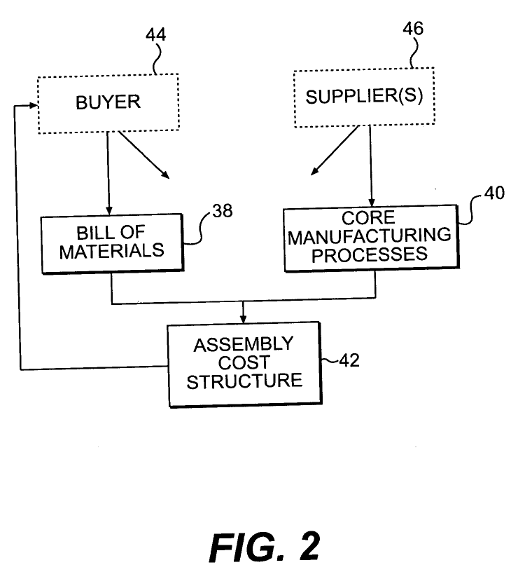

FIG. 2 shows a process flow chart of an illustrative embodiment for determining an assembly cost structure 42 of an assembly. The process of determining assembly cost structure 42 may include defining a bill of materials (BOM) 38 and/or a list of core-manufacturing processes (CMP) 40. BOM 38 and/or CMP 40 may be defined by a buyer 44 and/or one or more suppliers 46. It is also contemplated that one or more third parties may also define BOM 38 and/or CMP 40. Additional, fewer, or similar processes may be used to determine assembly cost structure 42.

Buyer 44 may initially determine BOM 38 for a specific assembly. BOM 38 may list any number of materials, components, subcomponents, and any other parts required for assembly manufacture. For example, a hose assembly may list components such as tubing, connectors, mounting brackets, etc. Subcomponents for a mounting bracket may include support members, nuts, bolts, etc. The terms “material”, “component”, “subcomponent” or “part” may be used interchangeably and may be defined as any object that may be used for assembly manufacture. BOM 38 may list any material required for the final assembly, assembly manufacture, assembly storage, assembly shipping, or any other design requirement. BOM 38 may include one or more materials.

Suppliers 46 may also contribute to defining BOM 38. For example, suppliers 46 may possess additional or more recent material information as compared to buyer 44. Suppliers 46 may be aware of less costly equivalent materials or acceptable alternatives for a particular material. It is contemplated that BOM 38 may be determined by one or more suppliers 46. Negotiations between several suppliers 46 may be required to sufficiently define BOM 38 acceptable to buyer 44 and suppliers 46. Further, BOM 38 may be defined by a third party. For example, a consulting engineer may contribute to the selection of a particular assembly material.

BOM 38 may contain a list of standard components and associated information. In particular, the list of components may include a list of part numbers that designate specific materials for assembly manufacture. The associated information may include any description that may define any material specification. For example, BOM 38 may contain a list of socket connectors and specify size requirements for the various socket connectors. It is also contemplated that materials listed in BOM 38 may be used for the manufacture of one or more assemblies. A specific material may be used in the manufacture of various assemblies, such as, for example, standard tubing, electrical wire, lug nuts, etc.

CMP 40 for an assembly may be determined based upon input from buyer 44 and/or suppliers 46. CMP 40 may list any number of manufacturing processes for producing an assembly in accordance with a design specification. For example, a design may specify a complete assembly, partial assembly, or assembly modified for specific shipping requirements. In particular, multiple sub-assemblies may be manufactured separately and combined to complete an assembly. It is also recognized that buyer 44 and suppliers 46 may negotiate to determine CMP 40. In addition, CMP 40 may be determined by any appropriate third party. For example, a third party consulting engineer may determine a cost efficient assembly manufacturing method.

CMP 40 may include one or more processes defined as a single core manufacturing process. For example, processing electrical wire may include separating a desired length of wire from a master roll, stripping the wire ends of insulation, placing the wire in partially completed assembly, and adhering the wire to the partially completed assembly. These four processes may be required for wire of any gauge. These four process may also be defined by a single core manufacturing process. The costs associated with the four processes may be combined into a single core manufacturing process. CMP 40 may include one or more core manufacturing processes.

CMP 40 may contain a list of manufacturing processes and associated information. The list of manufacturing processes may include a list of process numbers that designate specific processes for assembly manufacture. The associated information may include any description required to sufficiently define a manufacturing process. For example, CMP 40 may contain a list of processes used to join two pieces of electrical wiring. CMP 40 may also include associated information, such as, for example, suitable joining methods, joint specifications, etc. It is also contemplated that manufacturing processes listed in CMP 40 may be used for the manufacture of one or more assemblies. A specific process may be used in the manufacture of various assemblies, such as, for example, joining wires of different gauge, inserting tubes into sockets, testing weld strength, etc.

Assembly cost structure 42 may include information from BOM 38 and/or CMP 40. In addition, assembly cost structure 42 may include any appropriate information, such as, for example, numbers of materials, numbers of processing steps, material costs, processing costs, etc. Assembly cost structure 42 may further include subtotal costs, total costs and other cost information. It is also contemplated that assembly cost structure 42 may include one or more BOM 38 and one or more CMP 40. Assembly cost structure 42 may also include other data formats representing the information contained within BOM 38 and/or CMP 40.

Buyer 44 and suppliers 46 may negotiate a specific assembly cost structure 42 for a particular assembly. Agreement by buyer 44 and suppliers 46 on BOM 38 and CMP 40 may be required to ensure standardized assembly manufacture. Assembly cost structure 42 may be reviewed by buyer 44 or suppliers 46, and may be subject to mutual agreement. Specifically, assembly materials and/or manufacturing processes may change. For example, a new less-costly tubing may become available and may be a suitable replacement for an existing tubing. Buyer 44 may desire to include the new tubing in an assembly design, but suppliers 46 may desire time to adapt manufacturing processes to accommodate the new tubing. Therefore, agreement between parties may be necessary before the new material may be included in BOM 38 and/or CMP 40. Following acceptance of updated BOM 38 and/or CMP 40, assembly cost structure 42 of one or more assemblies may be updated to reflect the agreed upon changes. It is contemplated that any information within assembly cost structure 42 may be modified, as described above.

Assembly cost structure 42 may further include materials and/or processes whose cost may vary without input and/or agreement by buyer 44 and/or suppliers 46. The cost of certain materials and/or processes may fluctuate. For example, the material cost of copper wire may fluctuate. In order to account for the fluctuating cost of copper wire, assembly cost structure 42 may include a copper index that tracks price fluctuations of copper. The index may be updated by automated means, such as, for example, accessing a metals trading index. Such cost changes may apply to one or more assembly cost structures 42.

Any information modified within assembly cost structure 42 for a single assembly may be automatically applied to assembly cost structures 42 of any number of assemblies. By defining discrete materials and/or processes for assembly manufacture, modifications to such discrete elements may apply to the manufacture of one or more assemblies. For example, an improved material and/or process may be utilized in the manufacture of ten different assemblies. Agreement between buyer 44 and suppliers 46 to the improved material and/or process may be more efficient than if the improved material and/or process was considered for ten different assembly cost structures 42.

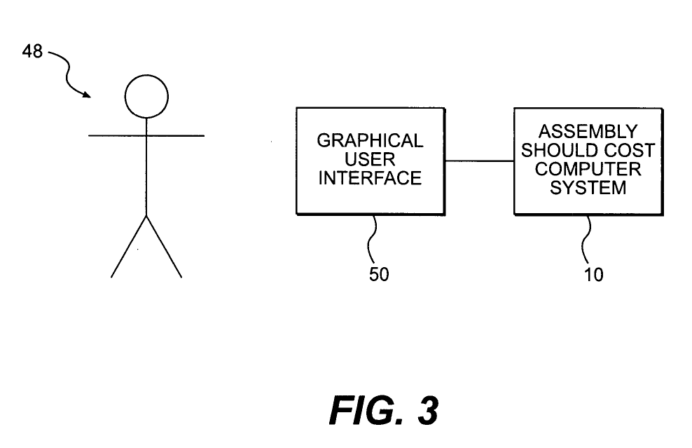

FIG. 3 illustrates a graphical user interface (GUI) 50 available to an approved user 48. User 48 may utilize GUI 50 to access ASC computer system 10. User 48 may include suppliers 46, buyer 44, or any authorized user. It is contemplated that appropriate access restrictions may limit access to ASC computer system 10. For example, an individual supplier may be allowed access to its own cost information, but not to other supplier's cost information. In the illustrated embodiment, a web-based interface allowing users to access ASC computer system 10 is described. It is also contemplated that other communication means and/or protocols may be used, such as, for example, text interfaces, voice systems, PDA protocols, etc.

Suppliers 46 may use GUI 50 to select one or more assembly numbers from a list of assembly numbers and a corresponding date. The date may specify when the cost information in the ASC computer system 10 was last updated. Following date and assembly selection, an individual supplier may obtain a report detailing materials and/or processes required for the selected assembly. The report may include material, process or any other pertinent information.

Materials information may include a list of materials, material description, quantity, part cost, total cost, and any other material information. GUI 50 may also include item totals and indicate if cost information is not available or incomplete. User 48 may be notified if cost information is absent or incomplete. Notification may include visual, audio or any other appropriate notification.

GUI 50 may also include means to access and/or modify variable material cost indexes. For example, a cost index for copper may be included in assembly cost structure 42 listing copper wire. ASC computer system 10 may track the cost index by any appropriate means. For example, ASC computer system 10 may track a copper cost index via a web-based service, manual periodic update, negotiated pricing structure, basket of indexes, etc. The cost index may be updated periodically, such as, for example, real-time, daily, monthly, quarterly, etc.

GUI 50 may show a list of manufacturing processes and related information. The process list may include a complete or partial list of CMP 40 that may be used to produce an assembly. GUI 50 may include processing information, such as, for example, process description, cost, pending cost, last-approved date, and/or total cost. Pending cost information may include proposed cost modifications to CMP 40.

GUI 50 may provide information as to when the last time costs were updated and/or reviewed. Specifically, the “last-approved date” information may provide user 48 with the date corresponding to the last time costs were reviewed. Knowing when costs were last reviewed, an individual supplier may or may not submit a request for a cost change to buyer 44. An individual supplier may review the responses of buyer 44 to requests for cost changes. Notification of acceptance or denial of cost change may be by any appropriate means, such as, for example, email or by updating ASC database 22.

GUI 50 may also allow an individual supplier to exchange material and/or process information with ASC computer system 10. The material and/or process information may be exchanged in batch form via any suitable means, such as, for example, a spreadsheet. The spreadsheet may contain detailed material and/or processing information that may be used by suppliers 46, such as, for example, materials, processes, delivery dates, production schedules, etc. ASC computer system 10 may allow an individual supplier to download a spreadsheet containing information for a particular assembly. The spreadsheet may be used by an individual supplier for internal purposes to more efficiently exchange information. It is contemplated that the spreadsheet may be modified by suppliers 46. In addition, a spreadsheet may be uploaded into ASC computer system 10. For example, the information contained within the spreadsheet may be used to update ASC database 22. It is also contemplated that ASC computer system 10 may be directly linked via a communication protocol to one or more supplier computer systems 18.

GUI 50 may show batch size information. Batch size may include any information defining a group of manufactured assemblies. Specifically, batch size information may include a volume range, batch size, and other information associated with batch size information. For example, if buyer 44 requires one hundred assemblies, the batch size may be set at ten assemblies. If buyer 44 requires one thousand assemblies, the batch size may be set at one hundred assemblies. Larger batch sizes may correspond to reduced costs as manufacturing costs may be reduced or large batch sizes may allow other cost savings. GUI 50 may allow buyer 44 and/or suppliers 46 to edit or delete specific batch size information.

An individual supplier may also access volume discount information using ASC computer system 10. Volume discount information may include numbers of parts, percentage cost reduction, and other pricing terms related to part quantities. For example, manufacturing large volumes of assemblies may reduce manufacturing and assembly costs. GUI 50 may allow buyer 44 and/or suppliers 46 to edit or delete specific volume discount information.

Suppliers 46 may not require cost allocations for all materials and/or processes listed in assembly cost structure 42. It is contemplated that an individual supplier may not require a specific material and/or process for the manufacture of an assembly. The corresponding cost associated with that material and/or process may be entered as zero. For example, an individual supplier may utilize manufacturing methods that combine several manufacturing processes into a single step. The supplier may then enter a cost associated with only one of processing step, and enter zero for the remaining processes. It is also contemplated that an individual supplier may not require a material for assembly manufacture. For example, a specific material may be required if an assembly is shipped by air. An individual supplier may use ground transportation to ship an assembly, removing the need for the specific material required for air transport. In such circumstances the supplier may enter zero cost associated with the specific material as it is not required for shipping the assembly by ground.

Suppliers 46 may require additional materials and/or processes to manufacture an assembly. Costs associated with additional materials and/or processes may be combined with the costs associated with existing materials and/or processes. For example, an individual supplier may utilize manufacturing methods that use several manufacturing processes instead of a single process listed in CMP 40. The supplier may then enter a single cost associated with several processing steps. It is also contemplated that an individual supplier may require additional material for assembly manufacture. For example, an individual supplier may use subcomponents of a component listed by BOM 38. The individual supplier may enter the combined cost of the subcomponents as the cost of a single component listed by BOM 38.

Suppliers 46 may generate assembly manufacture reports using ASC computer system 10. Reports may include charts, graphs, or any other suitable format to display information. Reports may also notify user 48 that information fields have not been entered, and/or information fields contain zero. Such notification may allow user 48 to ensure the data entered is correct. Further, reports may include additional material and/or process information not listed above. For example, a report may include delivery information, shipping instructions, assembly status, customer satisfaction ratings, etc. A report may organize information, such as, for example, order information chronologically. Specifically, supplier 46 may track cost history, payments received, delivery delays, etc. Chronological information may allow an individual supplier to analyze past performance and target possible improvements.

GUI 50 may be made available to user 48 within an organization associated with buyer 44. GUI 50 may be customized and/or designed for specific users 48 within an organization associated with buyer 44. Specific users 48 may require different access privileges and/or access to different information within ASC computer system 10.

GUI 50 may allow user 48 to select information to generate a report. User 48 may select one or more parameters to define the report. For example, user 48 may select a specific date, one or more suppliers 46, and one or more assemblies. The report may include an assembly number and description information, supplier 46 information, cost information, total costs and other information required for assembly manufacture comparison. GUI 50 may also include a legend highlighting additional information. For example the legend may include lowest cost, highest cost, cost outside a specified range, incomplete cost data, etc. The report may further include charts, graphs or any other means to compare information.

GUI 50 may include data embedded with the report information. Specifically, additional embedded information pertaining to the report information may be accessed by user 48. For example, specific assembly, individual supplier, cost or other report information may be selected by user 48. Additional information pertaining to the report information may be displayed. For example, additional information may include detailed manufacturing history of an individual supplier, detailed assembly cost analysis, etc. It is also contemplated that GUI 50 may contain other links, such as for example, to Internet URLs, ASC database 22, etc.

GUI 50 may show processing costs for an individual supplier and/or assembly. User 48 may select an individual supplier, assembly and/or operation by any appropriate means, such as, for example, from drop-down menus. GUI 50 may also include relevant processing information, such as, for example, a brief process description, process cost, dates, etc. GUI 50 may also allow buyer 44 to approve or reject requests for changing processing costs by suppliers 46. Specifically, GUI 50 may include requested cost changes and associated check boxes. Buyer 44 may select an appropriate check box and then select an “approve” or “reject” button. Further, a comments section may be provided to allow buyer 44 to communicate with suppliers 46. The communication may, for example, include reasons the cost changes were accepted or rejected. GUI 50 may show material cost information in a similar format to that for processing costs.

GUI 50 may show estimated annual usage information. Buyer 44 may select one or more assemblies and display corresponding estimated annual usage information. GUI 50 may include other assembly information, such as, for example, assembly description, dates, actual assembly usage, etc. Further, GUI 50 may allow buyer 44 to update estimated annual usage information. Specifically, buyer 44 may specify an updated estimate of annual usage for one or more assemblies. GUI 50 may show volume discount information and may include a similar format to that for estimated annual usage.

GUI 50 may also allow buyer 44 to exchange material and/or process information with ASC computer system 10. The material and/or process information may be exchanged in batch form via any suitable means, such as, for example, a spreadsheet. The spreadsheet may contain detailed material and/or processing information that may be used by buyer 44, such as, for example, materials, processes, delivery dates, production schedules, etc. ASC computer system 10 may allow buyer 44 to download a spreadsheet containing information for a particular assembly. The spreadsheet may be used by buyer 44 to efficiently exchange information with ASC computer system 10. It is contemplated that the spreadsheet may be modified by buyer 44. In addition, a spreadsheet may be uploaded into ASC computer system 10. For example, the information contained within the spreadsheet may be used to update ASC database 22. It is also contemplated that buyer 44 may also download and/or upload a spreadsheet containing estimated annual usage information. ASC computer system 10 may also interact with any buyer hardware and/or software.

It is contemplated that GUI 50 described above may include additional, fewer, and/or different features than listed above. It is understood that the type and number of listed features are illustrative and not intended to be limiting.

### INDUSTRIAL APPLICABILITY

ASC computer system 10 is designed to allow a user to determine the cost of an assembly. Assembly cost may be defined by the costs of materials used to manufacture the assembly and the costs associated with processing the materials to form the assembly. ASC computer system 10 may include a computer system that utilizes material and processing costs to determine assembly cost. Moreover, ASC computer system 10 may allow a buyer to validate quotations received by suppliers, determine assembly cost during an assembly design process, or function as part of an ordering application. ASC computer system 10 may also allow one or more suppliers to provide pre-defined material and processing cost data for the manufacture of one or more assemblies, update their costing data, or analyze their costing information.

ASC computer system 10 may be used in any industry requiring procurement of parts, such as, for example, heavy industry, automotive, defense, aerospace, computer, OEM, etc. ASC computer system 10 may be used by buyer 44 to analyze assembly manufacture information provided by suppliers 46. For example, ASC computer system 10 may be used during assembly design, analysis of quotations submitted by suppliers 46 or assembly ordering. The operation of ASC computer system 10 will now be described.

ASC computer system 10 may be used to standardize the materials and/or processes for manufacturing one or more assemblies. Reducing the manufacture of one or more assemblies to lists of pre-defined materials and/or processing steps may offer several advantages over existing systems. For example, the manufacturing information contained within assembly cost structure 42 may allow buyer 44 to accurately compare material and/or processing costs from suppliers 46. Traditional comparisons of assembly manufacture have generally relied upon less detailed information, such as, for example, total assembly cost, summation of component costs, etc. ASC computer system 10 may allow comparison of total or discrete costs for materials and/or processes of assembly manufacture of one or more suppliers 46 to be compared and analyzed in detail. Buyer 44 may compare and analyze the assembly cost structure 42 of an assembly for each individual supplier and may determine which costs vary.

Other advantages of defining assembly manufacture by assembly cost structure 42 may be possible. For example, BOM 38 may contain a list of materials used in the manufacture of one or more assemblies. Different assemblies may be manufactured from a common set of materials. Changes to a particular material may occur, such as, for example, availability, cost, specification, etc. Material information within BOM 38 may be updated to reflect the changes to the particular material. The updated material information may affect one material used for the manufacture of more than one assembly. The assembly cost structure 42 of the more than one assembly may be updated by updating the information for the one particular material. Consequently, one change to material information may affect the assembly cost structures 42 of numerous assemblies. Therefore ASC computer system 10 may reduce the time to update material and/or process changes by considering only the material and/or process changed. ASC computer system 10 may automatically update assembly cost structures 42 of the assemblies affected by material and/or process changes.

CMP 40 may include a complete or partial list of discrete processes required to provide an assembly. CMP 40 may provide parties the ability to establish costs for discrete manufacturing processes. Establishing discrete manufacturing costs may allow parties to analyze processing steps and determine costs associated with specific manufacturing processes. For example, supplier A may use ten processes to form an assembly for a total processing cost of Y dollars per assembly. Supplier B may use five processes to form the same assembly for a total processing cost of X dollars per assembly. Without an agreed list of CMP 40, assembly processing cost comparisons between suppliers A and B may be inaccurate as different processes may be compared. Alternatively, if suppliers A and B agreed to the same CMP 40, appropriate processing cost comparisons may be made. Analysis of CMP 40 cost data may be used to determine which supplier has the lowest costs associated with discrete manufacturing processes. For example, an individual supplier may submit a quotation significantly more than the quotations of other suppliers 46. Buyer 44 may analyze assembly cost structure 42 for the individual supplier and determine which costs are significantly more. The individual supplier may have high processing costs due to one high discrete processing cost. Buyer 44 may query the high discrete processing cost and may determine that the individual supplier is using inefficient manufacturing equipment. Once aware of the inefficient manufacturing, the individual supplier may update their equipment and become more cost efficient.

Suppliers 46 may also benefit from utilizing assembly cost structures 42 for assembly manufacture. Suppliers 46 may analyze and benchmark their own suppliers of materials and/or manufacturing processes. Analysis may reveal information to further improve suppliers 46 performance, such as, for example, switching from high-cost to less-costly materials, updated to more efficient manufacturing equipment, etc. It is also contemplated that suppliers 46 utilizing ASC computer system 10 may update their manufacturing information by updating assembly cost structures 42. Suppliers 46 may update BOM 38, CMP 40 and/or assembly cost structure 42 on a periodic basis. Such periodic updates may allow suppliers 46 to efficiently pass on cost increases to buyer 44.

Suppliers 46 may partially integrate ASC computer system 10 within their own internal computer systems to further improve efficiencies. Specifically, supplier computer systems 18 may be adapted to communicate with ASC computer system 10. For example, data formats may be modified to enhance communication between buyer 44 and suppliers 46. Improved communication between buyer 44 and suppliers 46 may allow improved efficiencies and reduce errors by increasing automation between supplier computer systems 18 and ASC computer system 10.

ASC computer system 10 may be operated by multiple parties at different stages of a manufacturing process. Specifically, ASC computer system 10 may be used by supplier 46 when negotiating with sub-suppliers. For example, supplier 46 may negotiate with a sub-supplier to reduce a material cost if other sub-suppliers can provide the same material for lesser cost.

ASC computer system 10 may be used during assembly design. Characteristics of assembly design may correspond to information within assembly cost structure 42. For example, a hose assembly may include a junction requiring one or more materials listed in BOM 38. The junction may also require a joining process corresponding to a process of CMP 40. Characteristics of assembly design may be stored in ASC database 22 for use with other assembly designs.

Design engineer 30 may use ASC computer system 10 in conjunction with computer design software, such as, for example, Pro/ENGINEER (Parametric Technologies Corp., Needham, Mass.). During the design process, design engineer 30 may interact with ASC computer system 10 to determine an estimated assembly cost. Design engineer 30 may modify the assembly design and re-run ASC computer system 10 to determine the affect of design modifications on estimated assembly cost. It is also contemplated that ASC computer system 10 may operate within computer design software. For example, ASC computer system 10 may operate in real-time, using a current computer-based assembly design to estimate assembly cost. As design engineer 30 modifies the assembly design, ASC computer system 10 may update the estimated cost to reflect the design modifications. ASC computer system 10 may also recommend possible alternative materials and/or manufacturing processes. For example, ASC computer system 10 may recommend materials of lower cost that meet the required design specifications than those selected by design engineer 30.

ASC computer system 10 may be used as part of quotation validation. Buyer 44 may receive one or more quotations from one or more suppliers 46 for the manufacture of an assembly. Suppliers 46 may submit quotations for assembly manufacture at costs significantly different than the assembly costs estimated by ASC computer system 10. Buyer 44 may analyze the quotations in detail and may determine which material and/or processes are quoted at different prices than predicted. This process may allow buyer 44 to validate the quotations received by suppliers 46 by comparing the quotations with the estimated assembly cost. Buyer 44 may determine why the quotations are higher than expected by analyzing the information contained within the assembly cost structures 42 of suppliers 46.

ASC computer system 10 may be incorporated into an ordering process. For example, buyer 44 may require an assembly. Buyer 44 may use ASC computer system 10 to select a supplier based upon information stored within ASC database 22. Request for quotations from suppliers 46 may not be required as ASC computer system 10 may access cost information contained within assembly cost structures 42. The stored cost information of suppliers 46 may be used by buyer 44 to select one or more suppliers 46 to manufacture the assembly. Selected suppliers 46 may be notified of the order by existing methods or automated means connected to ASC computer system 10. For example, ASC computer system 10 may include functionality to automatically notify the selected suppliers 46 of the request for assembly manufacture. The request may also include price, quantity, delivery date, delivery location and other information.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A computer system for estimating the cost of an assembly, comprising:
a processor;
a database operably linked to the processor;
the processor configured to:
access an assembly cost structure stored in the database, wherein the assembly cost structure includes a bill of materials and a list of one or more core manufacturing processes; and
determine the cost of the assembly.

2. The computer system of claim 1, wherein the list of one or more core manufacturing processes includes a list of processes required to manufacture the assembly.

3. The computer system of claim 1, wherein the bill of materials includes a list of one or more components for use in manufacturing the assembly.

4. The computer system of claim 1, wherein the assembly cost structure is defined by a buyer and one or more suppliers.

5. The computer system of claim 4, wherein the assembly cost structure is modified by supplier request and buyer approval.

6. The computer system of claim 1, wherein the computer system is configured to communicate with one or more computer networks.

7. The computer system of claim 6, wherein the one or more computer networks includes a network associated with a buyer of the assembly.

8. The computer system of claim 6, wherein the one or more computer networks includes the Internet.

9. The computer system of claim 6, wherein the one or more computer networks can be accessed by at least one computer associated with a supplier.

10. A method for estimating the cost of an assembly, the method comprising:
defining an assembly cost structure, wherein the assembly cost structure includes a bill of materials and a list of one or more core manufacturing processes;
providing one or more suppliers with access to the assembly cost structure;
receiving the assembly cost structure information from the one or more suppliers;
storing the assembly cost structure information from the one or more suppliers;
analyzing the assembly cost structure information from the one or more suppliers; and
determining an estimated cost for the assembly based on the analysis of the assembly cost structure information from the one or more suppliers.

11. The method of claim 10, wherein the list of one or more core manufacturing processes includes a list of processes required to manufacture the assembly.

12. The method of claim 10, wherein the bill of materials includes a list of one or more components needed for manufacturing the assembly.

13. The method of claim 10, wherein the assembly cost structure is defined by a buyer and the one or more suppliers.

14. The method of claim 10, wherein the assembly cost structure is modified by a request from the one or more suppliers and dependent upon to buyer approval.

15. The method of claim 10, wherein the assembly cost structure information includes cost information associated with the bill of materials and the list of one or more core manufacturing processes.

16. The method of claim 15, wherein the method further includes summing the cost information associated with the bill of materials and the list of one or more core manufacturing processes.

17. The method of claim 10, wherein the method further includes selecting a supplier from the one or more suppliers for the manufacture of the assembly based upon the estimated cost of the assembly.

18. The method of claim 10, further including receiving updates to the assembly cost structure information from the one or more suppliers.

19. The method of claim 18, wherein the updates are received without making a request of the one or more suppliers.

20. The method of claim 10, wherein determining the assembly cost structure of the assembly includes analyzing information an assembly cost structure associated with a different assembly.

21. The method of claim 10, further including using the estimated cost of the assembly for design of the assembly.

22. The method of claim 10, wherein analyzing assembly cost structure information from one or more suppliers includes comparing assembly cost structure information from the one or more suppliers.

23. The method of claim 10, wherein receiving assembly cost structure information from the one or more suppliers includes receiving the assembly cost structure information via one or more computer networks.
